(19) United States
(12) Patent Application Publication
(10) Pub. No.: US 2025/0152474 A1
(43) Pub. Date: May 15, 2025

(54) PILL-CRUSHING MACHINE WITH PRE-BIASED CRUSHER

(71) Applicant: Serrano Medical Solutions Inc., Surrey (CA)

(72) Inventors: Karlheinz Schmitt, Benoni (ZA); Rudi Visser, Centurion (ZA)

(21) Appl. No.: 18/939,104

(22) Filed: Nov. 6, 2024

Related U.S. Application Data
(60) Provisional application No. 63/598,084, filed on Nov. 11, 2023.

(51) Int. Cl. A61J 7/00

(52) U.S. Cl. CPC A61J 7/0007

(57) ABSTRACT

In known machines only a portion of the cycle time is used for pill comminution. The machine disclosed herein has two separate drive mechanisms. A first mechanism is used for creating a crushing force on the pills. A second mechanism is used to rotate one of a pair of cups between which the pills are held. The crushing mechanism is biased upwards to a position from which crushing starts upon application of the crushing force, at the start of the cycle. Safety sensors allow operation of the machine only when the pills are properly loaded and the lid closed. During operation, signals from a vibration sensor may be monitored. When vibration falls below a threshold, indicating completion of pill comminution, the machine automatically stops.

### TECHNICAL FIELD

This application relates to pill-crushing machines. More specifically, it relates to the drive and control mechanisms for the machines.

### BACKGROUND

Often patients have difficulty swallowing medications in tablet or pill form; however for many medications, this is the only form in which it is available. Also, many pills come with coatings or are otherwise designed to break down after ingestion, but in cases where patients are very young, elderly, and/or ill, this breakdown of medication is disrupted and either occurs much slower than desired or not at all. In order to more easily and effectively administer medications in such cases, pills are often comminuted with a mortar and pestle or other mechanical device that generally crushes and/or grinds the pills between two hard surfaces. After the pills are comminuted, the powder is generally transferred to a container where it is mixed with fluid or food for administering to a patient.

In order to reduce cross-contamination and material loss, pairs of inexpensive, single use, nesting containers are used to comminute one or more pills between the bottoms of the nesting containers. These containers can then be separated and the comminuted medication can then be scraped and mixed or suspended in a fluid or food for administering to a patient.

State-of-the-art machines have one drive, which generates both the forces for crushing the tablets and for grinding them. On some machines, the drive has to lower a punch into the cups with the tablets to be crushed, in an approach stroke. All machines start by compressing a spring while turning the cups for grinding. The disadvantage of this is that no real grinding takes place until the spring is compressed enough to deliver the force required for crushing, i.e. breaking up the tablets into smaller pieces. By the time that this happens, the stroke is usually at its end, or close to it, and some grinding takes place only on the back stroke when the rotation of the spindle compressing the spring is reversed and the spring is decompressed. Even then, the grinding effect is usually so little that some machines stop the spindle again on about one third of the back stroke and do another forward stroke to the bottom, and then only complete the back stroke to the starting condition. This usually results in unnecessary long cycle times.

U.S. Pat. No. 5,067,666 to Sussman discloses a portable device for pulverizing pills to form a powder. The device includes a cam-driven spring-biased ram, which reciprocates once on a vertical axis into and out of engagement with a pill disposed therebeneath with sufficient localized force to pulverize the pill.

U.S. Pat. No. 6,508,424 to Marshall discloses a pill crusher having a motorized turntable in a lower container and a plunger with a cap.

U.S. Pat. No. 6,626,429 to Baswick et al. discloses a solid medicine crushing apparatus with a solenoid that engages a vertical crushing ram. A return spring moves the ram to a starting position when the solenoid is deenergized. A cup assembly is used for holding a medicine to be crushed.

U.S. Pat. No. 7,427,041 to Hall et al. discloses a pill crusher that has a paper cup receptacle having an upwardly open, frusto-conical recess for receiving a paper cup, a plunger having a frusto-conical shape complimentary to that of the recess, the plunger being above and coaxial with the recess, an electric motor and a reciprocating drive transmission between the electric motor and the plunger for displacing the plunger into and out of the recess. The reciprocatory drive transmission comprises a worm and nut drive transmission for rotating the plunger while displacing the plunger into the receptacle.

U.S. Pat. No. 7,543,770 to Peron et al. describes an automated pill crusher comprising a container arranged to hold at least one pill, means for producing a linear force in a first direction upon the pill, and means for producing a spring force in a second direction upon the pill.

U.S. Pat. No. 7,559,496 to Shewchuk describes a pill crushing device that has a mortar portion to engage a bottom tray, and a pestle portion to engage a top tray. A hammer portion extends between two pivotable lever arms and can contact the top tray.

U.S. Patent application 2018/0093276 to Fader et al. discloses an optical system for detecting the upper cup of a pair of pill-crushing cups in a crushing machine. Operation of the machine is prevented if the upper cup is absent, and enabled if the upper cup is present. An optional sensor may be included to detect whether a drawer containing the cups and pills is closed, which is used as a further condition that must be satisfied before crushing can be started.

This background is not intended, nor should be construed, to constitute prior art against the present invention.

### SUMMARY OF INVENTION

The present invention is directed to a pill-crushing machine (“machine” for brevity) with dual drive mechanisms. A mechanical drive, for example, is used for rotating one of the cups, while a pneumatic drive, for example, is used for generating the crushing force. The crushing mechanism is pre-biased by springs, for example, to a position from which crushing starts upon application of the crushing force. Various safety sensors are incorporated in the machine. Also included in some embodiments is a vibration sensor that detects when the pills have been adequately crushed and automatically stops the machine in response.

An embodiment of the present invention employs an air pump to generate the crushing force separately from the drive that controls the rotational force for grinding the crushed particles. The air pump may be a compressor, or a connected compressed air supply may be used. A compressed liquid or gel may also be used in some embodiments. This system has one or more advantages over the presently known state of the art. They are: (a) the full crushing force is available and acting on the tablets to be crushed almost immediately, e.g. within milliseconds of having started the crushing cycle, which may be initiated by closing the lid; (b) grinding is effective almost immediately, e.g. milliseconds after having started the crushing cycle, which may be initiated by closing the lid; (c) both grinding and crushing are fully effective for essentially the full duration of the cycle time, resulting in a substantially shorter overall cycle time and/or improved grinding quality per unit of operational time; (d) the grinding speed and crushing force may be independently variable; (e) the grinding speed and crushing force may be programmable according to a specific profile for difficult to crush tablets and these programs may be stored and retrieved; (f) there are no complicated and time-wasting reset procedures if a crushing cycle has been interrupted, as it is possible to start a new cycle immediately from where the machine stopped.

Disclosed is a pill-crushing machine comprising: a dish that is rotatable about its axis, translatable up and down, and biased upwards; a punch that is movable from a first position outside the dish to a second position inside the dish; a motor that rotates the dish when the punch is in the second position; and an actuator that increases an upward force on the dish when the punch is in the second position.

Also disclosed is a method of comminuting one or more pills between a nested pair of pill-crushing cups, the method comprising: biasing a dish of a pill-crushing machine upwards, the dish being rotatable; detecting that a lid of the pill-crushing machine is closed, the lid having a punch that projects into the dish; detecting that an upper pill-crushing cup of the nested pair is present in the dish; and simultaneously rotating the dish using a motor to rotate a lower pill-crushing cup of the nested pair and increasing, by an actuator, an upwards force on the dish.

This summary provides a simplified, non-exhaustive introduction to some aspects of the invention, without delineating the scope of the invention.

### BRIEF DESCRIPTION OF DRAWINGS

The following drawings illustrate embodiments of the invention and should not be construed as restricting the scope of the invention in any way.

FIG. 1 is a schematic cross-section of a pill-crushing machine, showing selected components thereof, according to an embodiment of the present invention.

FIG. 2 is a perspective view from the front and above of a pill-crushing machine, according to an embodiment of the present invention.

FIG. 3 is a perspective view from behind and below of a pill-crushing machine, according to an embodiment of the present invention.

FIG. 4 is a perspective view from the front and above of an open pill-crushing machine, according to an embodiment of the present invention.

FIG. 5 is a cross-sectional view from the side of an open pill-crushing machine, according to an embodiment of the present invention.

FIG. 6 is a perspective view from the front and above of a pill-crushing machine without its body and lid covers, according to an embodiment of the present invention.

FIG. 7 is a perspective view from behind and below of a pill-crushing machine without its body cover, according to an embodiment of the present invention.

FIG. 8 is a close-up of a portion of FIG. 5.

FIG. 9 is a flowchart showing operation of a pill-crushing machine, according to an embodiment of the present invention.

FIG. 10 is a flowchart showing automated stopping of a pill-crushing machine, according to an embodiment of the present invention.

### DESCRIPTION

### A. Glossary

The term “firmware” includes, but is not limited to, program code and data used to control and manage the interactions between the various modules of the system.

The term “hardware” includes, but is not limited to, the physical housing for a machine, as well as the internal frame, display screen, connectors, motor, pump, wiring, circuit boards and other physical components.

LCD-TFT—Liquid crystal display thin film transistor

The term “module” can refer to any component in this invention and to any or all of the features of the invention without limitation. A module may be a software, firmware or hardware module, and may be located in the machine, a user device or a server.

The term “network” can include both a mobile network and data network without limiting the term's meaning, and includes the use of wireless and/or hard wired connections, including buses, and may include connections to memory components.

PCB—Printed circuit board

POM—polyoxymethylene

The term “processor” or “processing circuitry” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs some or all of the steps in the flowcharts, whether they are explicitly described as being executed by the processor or whether the execution thereby is implicit due to the steps being described as performed by code or a module. The processors, if multiple, may be located together or geographically separate from each other. The term includes virtual processors and machine instances as in cloud computing or local virtualization, which are ultimately grounded in physical processors.

The term “software” includes, but is not limited to, program code that receives sensor signals, performs the computations and makes the decisions necessary for controlling the machine.

### B. Principle of Operation

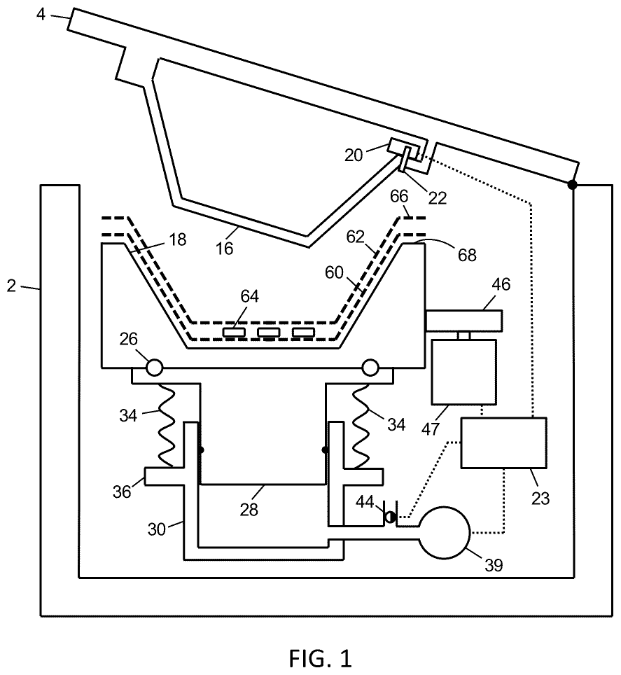

Referring to FIG. 1, a schematic, cross-sectional representation of a pill-crushing machine is shown. The machine has a body 2 to which a lid 4 is connected by a hinge. Projecting downwards from the underside of the lid 4 is a punch 16, which is fixed relative to the lid. Within the body 2 there is a dish 18 that is dimensioned to receive a pair of nested pill-crushing cups 60, 62. Between these cups there are one or more pills 64 that are to be crushed. The cups are typically identical for convenience, although this is not necessary. The dish is rotatable about the axis of symmetry of its wall, which is, for example, frustoconical, and conforms to the outer wall of a cup 60. This axis of symmetry may be arranged vertically, for example. The wall of the punch 16 has a shape that conforms to the inner wall of a cup 62, and the axis of symmetry of the punch wall aligns with that of the dish 18 when the lid is closed, so that the punch and dish are coaxial.

The dish 18 is translatable up and down and is biased upwards in the body 2 by one or more springs 34 that are mounted at their lower ends to a frame plate 36. As well as making it convenient for inserting the cup and pill load, the upward bias allows the punch to contact and potentially press down on the upper cup 62 as soon as the lid 4 is closed. As the lid 4 is closed, the punch 16 moves from a first position outside of the dish 18 to a second position inside the dish, sandwiching the load of cups and pills between the punch and the dish.

As soon as the lid is closed, which is detected by electric and/or electronic circuitry on PCB (printed circuit board) 23, a motor 47 starts to rotate a gear 46, which in turn rotates the dish 18 on bearings 26. The gear 46 and dish 18 are configured to allow relative vertical movement between each other. It is possible to have the drive motor 47 fixed and have a long gear configuration on the dish 18 so that the driving gear stays engaged with the driven gear while the dish 18 moves up and down. In other embodiments, the motor 47 and gear 46 move up and down with the dish 18. This avoids axial friction between the driving and the driven gear while under load due to the grinding forces. It prevents unnecessary wear on the gears and unnecessary electric power consumption. In some embodiments of the invention, the driving geared motor is mounted onto a bearing mounting housing immediately below the dish, so that the driving geared motor moves up and down together with the dish 18.

The lower cup 60 is mechanically engaged with the dish 18, for example via a polygonal rim on the lower cup that fits within a corresponding polygonal recess around the top of the dish. As a result, the lower cup rotates with the dish. The upper cup 62 does not rotate because it is mechanically engaged with the lid 4, for example via the polygonal rim of the upper cup fitting into a corresponding polygonal recess in the lid around the punch.

Also, as soon as the lid is closed, an actuator increases the upwards force on the dish 18. The actuator may be, or may include, a pneumatic device such as an air pump 39. As soon as the lid is closed, the electric circuitry starts the air pump 39, which pumps ambient air into a pneumatic cylinder 30, while valve 44 is closed. The air pumped into the cylinder 30 creates pressure on the piston 28, which increases the upward force on the dish 18. This additional upwards force crushes the pills, which is assisted by the lower cup 60 being rotated relative to the upper cup 62, and by the grinding arcs on the cup bases.

When grinding of the pills is sufficiently completed, the motor 47 stops, the air pump 39 stops and the pressure in the pneumatic cylinder 30 is released by opening valve 44.

Safety features may be included, such as a microswitch 20 in the lid 4. The presence of an upper cup 62 in the load in the dish causes the pin 22 of the microswitch 20 to trigger the microswitch when the lid is closed. If the lid is closed without a cup and pill load in the dish, or even with only a single cup in the dish, then the microswitch 20 is not triggered. This is because the thickness or height of the rim of cup 60 alone above the surface 68 of the dish is insufficient to reach the pin 22 of the microswitch. As a consequence, the machine does not start. Other microswitches may be connected to the PCB 23, for example, microswitches that detect the closure of the lid and the clasping of the lid in the closed position.

The electronic circuitry includes one or more processors and one or more processor-readable memories storing processor-readable instructions, which, when executed, cause operation of one or more of the functions of the machine. The instructions may be software or firmware or a combination of both.

### C. Exemplary Embodiments

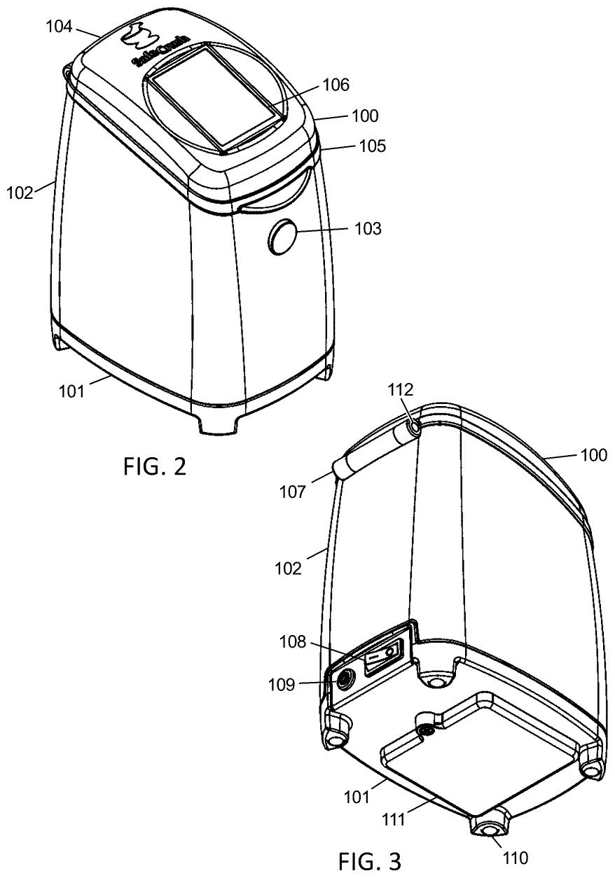

Referring to FIG. 2, the machine or appliance is built up from the bottom, starting with the body base 101, which is high pressure die cast from an aluminum alloy, and which incorporates a battery compartment. A body cover 102 is attached to the body base 101. A catch release button 103 is accessible through the body cover, which serves to unlatch the lid so that it can be opened. The lid 100 includes a lid cover 104 and a lid base 105. An LCD-TFT (liquid crystal display thin film transistor) touch screen display 106 is fitted to the lid 100 and is accessible to a user through the lid cover 104.

Referring to FIG. 3, the lid 100 of the machine is connected to an upper frame plate inside the machine by way of the lid hinge 107 with hinge pin 112. An on-off switch 108 and battery charging socket 109 are fitted into a raised panel at the rear of the body base 101. This has the advantage that electric control elements do not have to be removed from the body cover 102 when having to remove the body cover from the machine for maintenance purposes. Four rubber feet 110 are also clipped into the bottom of the body base to make the machine stand securely without sliding around on a moving trolley, for instance. For the purpose of battery replacement, the battery compartment is accessible via the battery compartment lid 111, which is injection molded from a PC-ABS (polycarbonate/acrylonitrile butadiene styrene) polymer. The battery compartment lid clips into the base on one side by means of two tabs and is held closed on the opposite side with a screw.

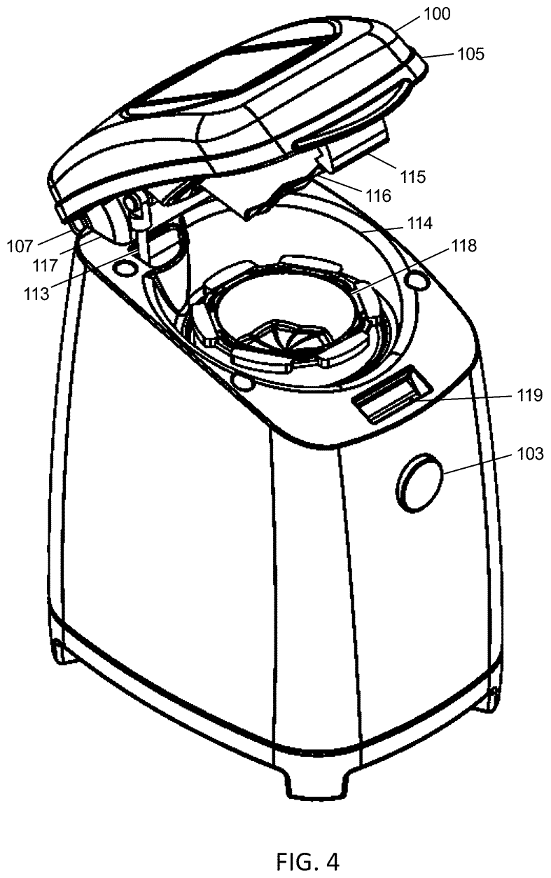

Referring to FIG. 4, the lid of the machine 100 is connected to an upper frame plate inside the machine by the lid hinge 107. The lid is also connected to a lower frame plate inside the machine by way of the lid hook 115 engaging with the catch hook 119 (or “catch”). As such, when closed, the lid is connected at both front and back to frame components inside the machine. When pushing the catch release button 103 in toward the machine against a spring, the catch hook 119 is pushed into the machine and thus disengages from the lid hook 115, which is an integral part of the lid base 105. Upon the catch hook 119 disengaging from the lid hook 115, the lid is automatically lifted to the open position, and kept there by means of a gas spring 113. The fixed crushing punch 116 is shown projecting down from the lid base 115. The punch is fixed so that it cannot move or rotate relative to the lid base. A cable passage 117 allows cables to connect the electric and electronic components in the lid to the electric and electronic components in the body of the machine. The rotary grinding dish 118 is visible in a crushing chamber 114 in the upper portion of the body of the machine.

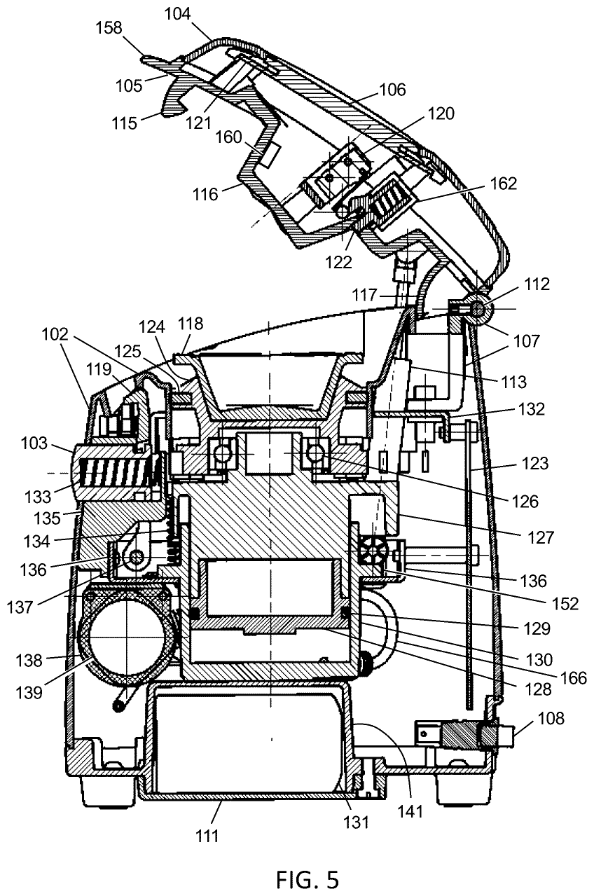

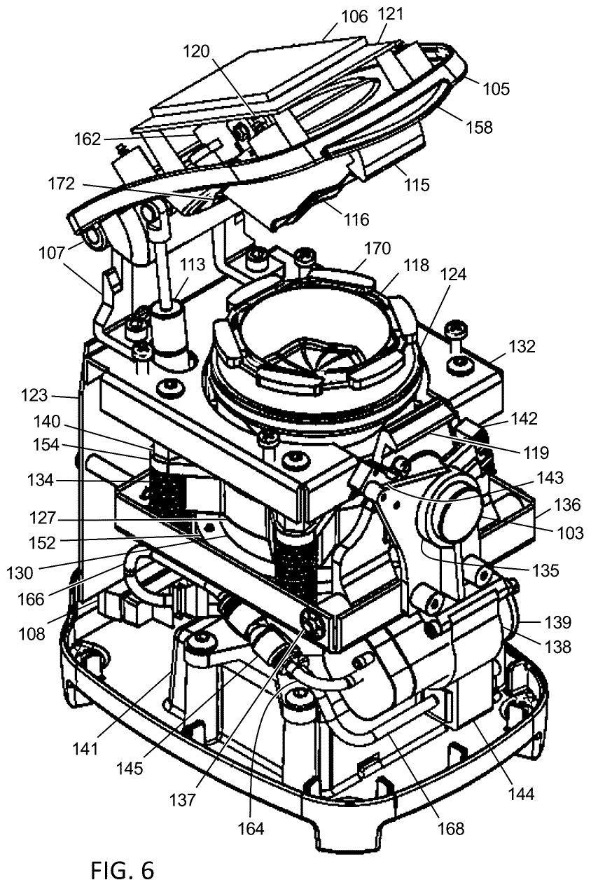

Referring to FIGS. 5 and 6, the battery compartment 141 at the bottom accommodates the battery pack 131, which supplies the electric power to operate the machine and its control elements. The battery compartment 141 is accessible via the battery compartment lid 111.

The pneumatic cylinder 130 is injection molded from POM (polyoxymethylene) polymer, and is attached to the body base 101 in a fixed position by means of a lower frame plate 136. The lower frame plate 136 is attached to the flange 152 of the pneumatic cylinder by four machine screws. Four tie bars 140 connect the lower frame plate 136 to the upper frame plate 132, the two frame plates together constituting the load frame of the machine. This load frame takes up all the forces that are generated by the crushing and grinding action of the machine. The pneumatic piston 128, coupled to the vertically moving bearing mounting (housing) 127 by way of a press fit, may move up and down inside the pneumatic cylinder 130. The O-ring seal 129 fitted to the pneumatic piston 128 facilitates pressure build-up between the pneumatic piston and the pneumatic cylinder. The required pressure is generated by the air pump 139, which is suspended in an anti- vibration mounting 138 molded from TPE (thermoplastic elastomeric polymer), to ensure a low noise level when operating. The air pump works in conjunction with the solenoid valve 144 also fitted to the anti-vibration mounting of the air pump. The air pump outlet, the pneumatic cylinder and the solenoid valve are connected with hoses 164, 166, 168 respectively to a Y-connector 145. When no pressure is required, the air pump and the solenoid valve are both de-energized. In this state, the solenoid valve connects the pneumatic cylinder port to atmosphere. When pressure is required, both the air pump and the solenoid valve are energized. With the pneumatic cylinder port now closed to the atmosphere by the solenoid valve, the rotating air pump, which is of the membrane type, can build up the pressure in the pneumatic cylinder up to 120 KPa, for example. This equals a force of 350 N, for example, available for crushing tablets. When the solenoid valve and the air pump are de-energized, the pressure is rapidly (almost instantly) removed from the pneumatic cylinder.

The vertically moving bearing mounting 127 is prevented from rotating by being guided by the four tie bars 140. Four lifting springs 134 for the bearing mounting 127 are mounted, one spring centrally per tie bar 140, and all four springs extend between the lower frame plate 136 and the underneath of the flange 154 of the vertically moving bearing mounting 127. These springs lift the vertically moving bearing mounting 127 towards its topmost position when the machine is not operating. The advantage of this is that when a crushing cycle is initiated, processing of the tablets to be crushed starts immediately on initiation of the cycle. This function is also required to detect if the operator has loaded the second cup before initiating a new crushing cycle.

An angular contact ball bearing 126 is mounted around the central axis of the vertically moving bearing mounting 127. As the angular contact ball bearing is able to carry loads both of a radial and an axial nature, it is ideally suited to deal with the radial grinding forces as well as the axial crushing forces with a minimal amount of friction. This helps to minimize the power requirements and so extends the number of crushes possible per battery charge.

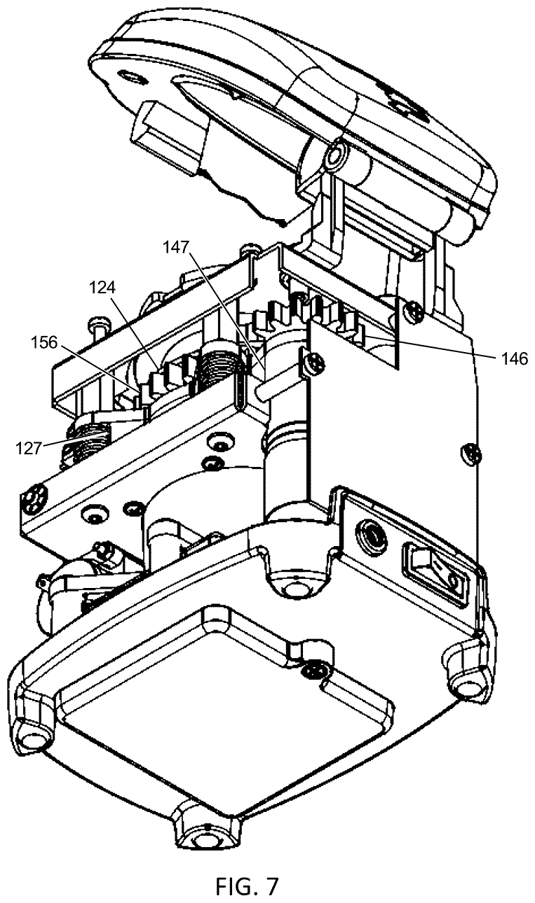

Referring briefly to FIG. 7, radially offset from the central axis of the vertically moving bearing mounting 127 is the geared motor 147 for the grinding table. This geared motor 147 drives a gear tooth formation 156 on the driven rotary grinding table 124 by means of the driving gear 146, which is mounted onto the drive shaft of the geared motor. The driven rotary grinding table 124, which is fitted centrally onto the angular contact ball bearing, is injection molded from a POM polymer with the driving gear tooth formation 156 embedded in the body of the driven rotary grinding table. The table is driven by the geared motor via the driving gear for grinding table, at a speed of up to 10 rpm, for example. In other embodiments, the speed may be faster, e.g. using a more powerful motor and/or a larger gearbox, which may reduce the crushing cycle time.

Referring back to FIGS. 5 and 6, a dust seal 125 manufactured from felt is fitted to the driven rotary grinding table 124, sealing against the body cover 102 to prevent any spilling tablet dust to reach the rotary bearing arrangement. In some embodiments, the felt seal is replaced with a moulded rubber seal made from TPE. The rotary grinding dish 118 is loosely fitted, but rotationally fixed to the grinding table 124 by way of a tooth formation. As such, the dish 118 may be removed for cleaning. The cups containing the tablets to be crushed are inserted into the rotary grinding dish 118 for every crushing cycle to be carried out. Six walls 170 with flat inner faces around the rim of the dish 118 engage with six corresponding straight edges of the rim of the lower pill-crushing cup when it is placed in the dish. These walls 170 cause the lower cup to rotate with the dish when the dish is rotated. In the lid base 105 there is a hexagonal recess 172 around the base of the punch 116 that corresponds to the hexagonal shape of the rim of the upper pill-crushing cup. This recess 172 prevents the upper cup rotating during the crushing and grinding operation.

The lid of the machine, which includes the lid base 105 and the lid cover 104, is connected to the upper frame plate 132 of the machine by means of the lid hinge 107 and hinge pin 112, and to the lower frame plate 136 by way of the lid hook 115 and catch hook 119. The catch hook 119 pivots about the release catch hinge pin 137. When unloading and loading the machine for tablet crushing, the lid is in the open position. When pushing the catch release button 103, which is guided in the button guide 135, in toward the machine against its button spring 133, the catch hook 119 is pushed inwards, releasing the lid hook 115 and allowing the lid to be opened by the gas spring 113.

After loading the tablet pack (i.e. tablets held between two crushing cups) to be crushed into the rotary grinding dish 118, the lid is closed manually, by pushing onto the lid base handle 158. The two microswitches, microswitch lid down 143 and microswitch lid securely locked 142, are then activated so that the initiating of the crushing cycle may be enabled. When closing the lid, the fixed crushing punch 116, which is part of the lid base 105, pushes down the whole vertically moving bearing mounting assembly by the approximate thickness of the cups with the tablets to be crushed, against the lifting springs 134 that hold the said assembly at the upper limit of the possible working stroke. This guarantees an economical movement of the working parts and facilitates short crushing time cycles.

The microswitch second cup presence 120 is mounted inside the fixed crushing punch section of the lid. The microswitch 120 is activated by the sensing pin 122 for the second (upper) cup presence, which normally pushes through the rim area of the fixed crushing punch onto the inner rim of the upper disposable cup that gets loaded for the tablets to be crushed. The sensing pin 122 is mounted in a sensing pin housing 162. When the lid is closed, the cup pack with the tablets inserted (i.e. the load) is pushed upwards against the lid and punch, which in turn pushes the sensing pin 122, causing the circuit in the microswitch 120 to be interrupted. This relays a signal to a microprocessor that the crushing cycle may be initiated. When the grinding takes place, the lower cup is rotated while the upper cup is prevented from rotating, and the pills are crushed between the two bases of the cups. Should the operator forget to place the second disposable cup onto the tablets to be crushed, the microswitch 120 will not be activated as the pin 122 will not be lifted, resulting in the crushing cycle being unable to be initiated until the mistake is rectified. Use of a microswitch 120 may be less expensive than using an optical beam to detect the presence of the upper cup, although in some embodiments this is possible.

The machine is controlled electronically by a microprocessor and supporting electronics, mounted on the electronics PCB 121 inside the lid of the machine. An LCD-TFT touch screen display 106 is fitted to the electronics PCB 121 with the operating face to the outside. This touchscreen displays the charging state of the battery pack, the continuous state of the operating cycle, all the control buttons and the company logo, for example. Paging through multiple screens it is possible to make changes to crushing cycle times and see a variety of information pertaining to the ongoing maintenance of the machine. Serial number and model number of the machine as well as maintenance and consumable supply information may be accessed through the display interface. There may be, for example, a four-cycle selection, of which three cycles are linked to various timers. The fourth cycle may be controlled automatically by way of a vibration sensor 160 built into the lid of the unit. With this fourth cycle, the cycle length may be controlled by the intensity of the vibration, which diminishes as the tablets are ground to a fine powder. With this automatic cycle, the crushing cycle length will be at its optimum. Any of the crushing cycles can at all times be interrupted by pushing a stop button on the display, or by simply pushing the catch release button which causes the lid to lift automatically and stop all crushing functions instantly, or by switching the machine off with the switch 108. No re-setting of the machine is necessary because the machine resets itself instantly should a cycle be interrupted.

A second, electrics PCB 123, is mounted onto the rear of the lower frame plate 136. All the electric switch gear for operating the motor, pump and the solenoid is mounted on this PCB as well as all the power management control elements. This PCB 123 is connected to the PCB 121 in the lid by way of a ribbon cable which passes through the ribbon cable passage 117.

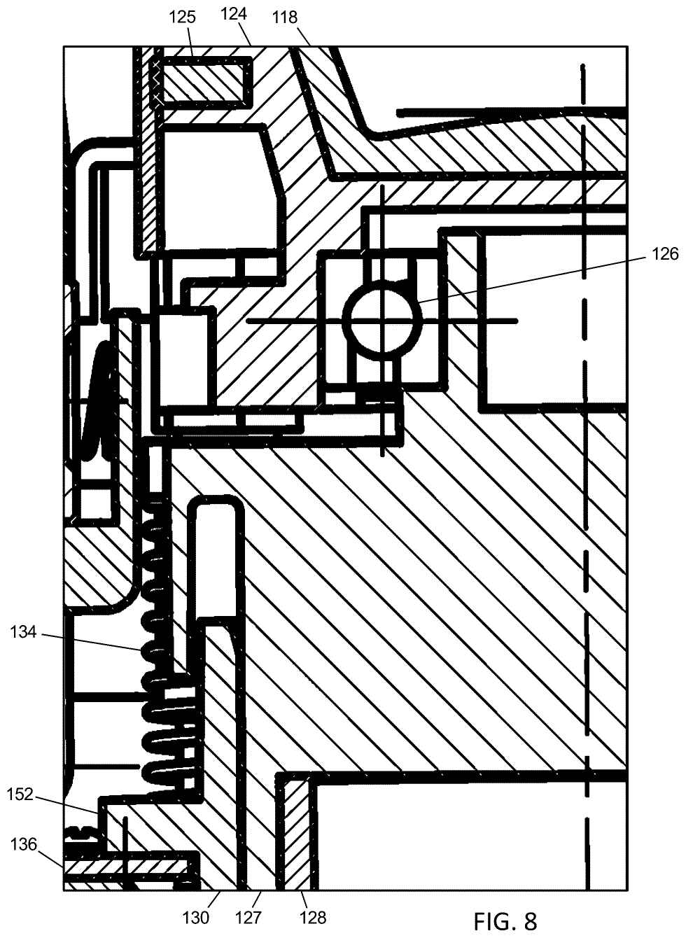

Referring to FIG. 8, a close-up of a portion of FIG. 5 is shown. Starting at the bottom of FIG. 8, the pneumatic piston 128 is shown connected to the vertically moving bearing mounting 127, both of which move up and down in the pneumatic cylinder 130. The flange 152 of the pneumatic cylinder 130 is connected to the lower frame plate 136, which also supports biasing spring 134. The spring 134 lifts the vertically moving assembly, which includes the pneumatic piston 128, the vertically moving bearing mounting 127, the bearings 126, grinding table 124, the dust seal 125 and the dish 118.

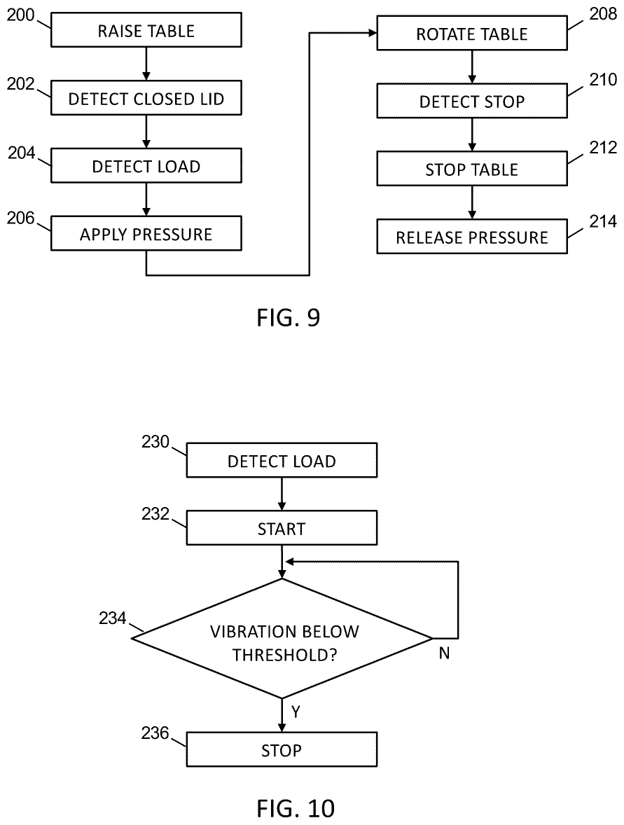

Referring to FIG. 9, a flowchart is shown for operation of the machine. In step 200, the grinding table that carries the dish is raised by biasing springs. After the pill and cup pack is loaded into the dish, the machine detects closure of the lid in step 202. In step 204, the machine detects that a suitable load has been placed in the dish in the grinding table. In step 206, the machine then applies a pressure upwards on the dish to provide a crushing force on the pills, and, at the same time, the machine rotates the grinding table in step 208. In step 210, the machine detects a stop command, following which the machine stops the rotation of the grinding table in step 212 and releases the pressure on the dish in step 214.

Referring to FIG. 10, a flowchart for using the vibration sensor is shown. In step 230, the machine detects that a suitable load has been placed into the dish in the grinding table. In step 232, the machine starts the grinding and crushing operations, by rotating the grinding table and applying an upward force on the dish respectively. In step 234, the machine determines whether the vibration in the machine, as detected by a vibration sensor, is below a threshold. If the level of vibration is not below the threshold, the machine continues to operate and the process reverts to step 234. If, in step 234, the level of vibration is below the threshold, the machine stops the crushing and grinding in step 236.

### D. Variations

In some embodiments, the piston may be replaced with another kind of actuator for providing the main, upwards crushing force on the dish. For example, the actuator may be a screw drive that is driven by a worm gear, or it may be a hydraulic actuator.

Other mechanical, pneumatic or hydraulic mechanisms may be used in other embodiments. The main requirement is that the crushing force be applied separately from the rotating force, or at least that the two forces are independently controlled. In some embodiments, the same prime mover may be used to provide the two forces via separate gear mechanisms.

In other embodiments, the pressure and force generated may be greater or lesser than the examples described above.

Locations of the various components may be in other positions in other embodiments. For example, the vibration sensor may be located on the vertically moving bearing mounting 127. As another example, the punch and upper cup may be rotated, while the lower cup is prevented from being rotated and is only forced upwards. For example, the punch and upper cup may be rotated by a motor and gear either in the lid or the body of the machine.

When the pill-crushing machine is resting on a horizontal plane, the axis of symmetry of the dish walls, about which the dish is rotated, may be arranged off-vertical in some embodiments.

In some embodiments, the dish 118 is biased upwards by other mechanisms, for example by a counterweight.

In some embodiments, the machine is user programable and linked via a Bluetooth™ communication protocol and an application to a smart phone, for example. This connection may also be used to facilitate remote connection for problem analysis.

Embodiments, depending on their configuration, may exhibit all or fewer than all of the advantages described herein. Other advantages not mentioned may be present in one or more of the embodiments.

Features from any of the embodiments may be combined with features from any of the other embodiments to form another embodiment within the scope of the invention.

In general, unless otherwise indicated, singular elements may be in the plural and vice versa with no loss of generality.

It will be clear to one having skill in the art that further variations to the specific details disclosed herein can be made, resulting in other embodiments that are within the scope of the invention claimed.

All proportions, dimensions, angles, materials, quantities and configurations described herein are examples only and may be changed depending on the specific embodiment implemented.

Throughout the description, specific details have been set forth in order to provide a more thorough understanding of embodiments of the invention. However, the invention may be practised without these specific details. In other instances, well known elements have not been shown or described in detail and repetitions of steps and features have been omitted to avoid unnecessarily obscuring the invention. Accordingly, the specification and drawings are to be regarded in an illustrative, rather than a restrictive, sense. It will be clear to one having skill in the art that variations to the details disclosed herein can be made, resulting in other embodiments that are within the scope of the invention claimed. Accordingly, the scope of the invention is to be construed in accordance with the substance defined by the claims.

1. A pill-crushing machine comprising:
a dish that is rotatable about its axis, translatable up and down, and biased upwards;
a punch that is movable from a first position outside the dish to a second position inside the dish;
a motor that rotates the dish when the punch is in the second position; and
an actuator that increases an upward force on the dish when the punch is in the second position.

2. The pill-crushing machine of claim 1, further comprising one or more springs that bias the dish upwards.

3. The pill-crushing machine of claim 1, wherein the actuator comprises a piston activated by an air pump.

4. The pill-crushing machine of claim 3, further comprising an anti-vibration mounting in which the air pump is mounted.

5. The pill-crushing machine of claim 1, further comprising:
a lid from which the punch projects downwards;
a catch that retains the lid closed; and
a spring that maintains the lid open and the punch in the first position when the lid is unlatched from the catch.

6. The pill-crushing machine of claim 5, further comprising:
a frame to which the catch is connected; and
a hinge connected between the frame and the lid.

7. The pill-crushing machine of claim 1, wherein:
the dish is dimensioned to hold a lower pill-crushing cup nested with an upper pill-crushing cup, with one or more pills between said pill-crushing cups;
the dish engages with the lower pill-crushing cup to rotate it when the dish rotates; and
a lid of the pill-crushing machine engages with the upper pill-crushing cup to prevent it rotating when the dish rotates.

8. The pill-crushing machine of claim 1, further comprising:
a table in which the dish is mounted, wherein the motor rotates the table to rotate the dish; and
one or more bearings upon which the table is mounted;
wherein the dish is removable.

9. The pill-crushing machine of claim 8, further comprising:
a first gear attached to the motor and rotated by the motor; and
a second gear in the table and rotated by the first gear.

10. The pill-crushing machine of claim 8, further comprising:
an upper frame plate;
a lower frame plate;
one or more tie bars between the upper frame plate and lower frame plate;
a bearing mounting upon which the one or more bearings are mounted;
wherein:
the actuator comprises a piston activated by an air pump;
the bearing mounting is mounted on the piston; and
the one or more tie bars prevent the piston and bearing mounting from rotating.

11. The pill-crushing machine of claim 1, further comprising:
a lid;
a first microswitch located in the lid to detect a presence in the dish of an upper pill-crushing cup of a nested pair of pill-crushing cups; and
a second microswitch located to detect that the lid is closed.

12. The pill-crushing machine of claim 11, further comprising:
a catch; and
a third microswitch located to detect that the catch has hooked the lid.

13. The pill-crushing machine of claim 1, further comprising:
a lid base;
a touchscreen mounted on the lid base; and
a lid cover that exposes the touchscreen.

14. A method of comminuting one or more pills between a nested pair of pill-crushing cups, the method comprising:
biasing a dish of a pill-crushing machine upwards, the dish being rotatable;
detecting that a lid of the pill-crushing machine is closed, the lid having a punch that projects into the dish;
detecting that an upper pill-crushing cup of the nested pair is present in the dish; and
simultaneously:
rotating the dish using a motor, to rotate a lower pill-crushing cup of the nested pair; and
increasing, by an actuator, an upwards force on the dish.

15. The method of claim 14, wherein the actuator comprises an air pump and a piston.

16. The method of claim 14, further comprising engaging the lid with the upper pill-crushing cup to prevent the upper pill-crushing cup from rotating while the lower pill-crushing cup is rotated.

17. The method of claim 14, further comprising:
detecting that a vibration level in the pill-crushing machine has fallen below a threshold; and, in response,
stopping the dish rotating and reducing the upwards force on the dish.
